(19) United States
(12) Patent Application Publication
(10) Pub. No.: US 2022/0356655 A1
(43) Pub. Date: Nov. 10, 2022

(54) UTILITY DUCTS AND VAULTS FOR VEHICLE/PEDESTRIAN CROSSINGS

(71) Applicant: SAUDI ARABIAN OIL COMPANY, Dhahran (SA)

(72) Inventors: Waseem Khatri, Dhahran (SA); Saleh Ali Alwehaiby, Dhahran (SA); Mirza Mansoor Baig, Dhahran (SA)

(73) Assignee: SAUDI ARABIAN OIL COMPANY, Dhahran (SA)

(21) Appl. No.: 17/313,588

(22) Filed: May 6, 2021

(51) Int. Cl. E01C 5/00; E01C 3/00; F16L 1/028; F16L 3/12; F16L 1/06

(52) U.S. Cl. CPC E01C 5/003; E01C 3/003; F16L 1/028; F16L 3/12; F16L 1/06

(57) ABSTRACT

A system for enclosing a utility line under a roadway or footway includes a plurality of modular walls formed from a polymer material, wherein the modular walls combine to form a duct unit defining an interior volume therewithin and having open axial ends. The system further includes a polymer plate overlaying the duct unit, a quantity of granular base material overlaying the polymer plate, and a plurality of interlocking paving blocks overlaying the granular base material, wherein the plurality of paving blocks combine to form a surface for accommodating foot or vehicular traffic. Further, the system includes one or more brackets removably fixed in the duct unit for holding the utility line within the interior volume.

### BACKGROUND

In industrial and residential settings alike, utility lines such as pipes (for water, natural gas, etc.) and cables (for electricity, telephone landlines, fiberoptic, etc.) often need to cross roadways and footways, including, for example, primary roads, secondary roads, access roads, sidewalks, footpaths, and bicycle paths. If utility lines cross underneath roadways and footways, normally a rudimentary duct or encasement may be provided around the utility lines, which may then be covered with a roadway or footway using customary roadway or footway construction processes. When utility lines provided under roadways or footways are in need of repair or replacement, the utility lines may be accessed by cutting portions of the roadway or footway in a manner that may then require a significant rebuild of the pavement. Such processes are cumbersome, invasive, and typically expensive. Accordingly, it remains a steep challenge to afford easier access to utility lines under roadways and footways, especially in a manner that economizes on the total time and effort involved.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system for enclosing a utility line under a roadway or footway. The system includes a plurality of modular walls formed from a polymer material, wherein the modular walls combine to form a duct unit defining an interior volume therewithin and having open axial ends. The system further includes a quantity of granular base material overlaying the duct unit and a plurality of interlocking paving blocks overlaying the granular base material, wherein the plurality of paving blocks combine to form a surface for accommodating foot or vehicular traffic. Further, the system includes one or more brackets removably fixed in the duct unit for holding the utility line within the interior volume.

In one aspect, embodiments disclosed herein relate to a method which includes providing, to a work site: a plurality of modular walls, wherein the modular walls are formed from a polymer material; a quantity of granular base material; and a plurality of interlocking paving blocks. The method further includes: assembling the modular walls to form a duct unit defining an interior volume therewithin and having open axial ends; removably fixing the one or more brackets in the duct unit to hold a utility line within the interior volume; overlaying the quantity of granular base material over the duct unit; and overlaying the plurality of interlocking paving blocks over the base material, wherein the plurality of paving blocks combine to form a surface for accommodating foot or vehicular traffic.

In one aspect, embodiments disclosed herein relate to a system for enclosing a utility line under a roadway or footway. The system includes a plurality of modular walls formed from a polymer material, wherein the modular walls combine to form a duct unit defining an interior volume. The system further includes a quantity of granular base material overlaying the duct unit and a plurality of interlocking paving blocks overlaying the granular base material, wherein the plurality of paving blocks combine to form a surface for accommodating foot or vehicular traffic. Further, the system includes one or more structural elements for holding the utility line within the interior volume.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 schematically illustrates a road grid at an industrial site where duct units are installed, in accordance with one or more embodiments.

FIG. 2 is a schematic, elevational cross-sectional view of an installed duct unit and ancillary components, in accordance with one or more embodiments.

FIG. 3 is an elevational cross-sectional view of a utility duct with a U-shaped lower portion, in accordance with one or more embodiments.

FIG. 4 is an elevational cross-sectional view of a utility duct with L-shaped side walls, in accordance with one or more embodiments.

FIG. 5 is an elevational cross-sectional view of a utility duct with upper and lower “half square” structural portions, in accordance with one or more embodiments.

FIG. 6 is an elevational cross-sectional view of a utility duct with upper and lower “half pipe” structural portions, in accordance with one or more embodiments.

FIG. 7 is an elevational cross-sectional view of a utility duct for installation under a footway.

FIG. 8A is a side elevational, cross-sectional view of a utility vault, in accordance with one or more embodiments.

FIG. 8B is front elevational view of the utility vault of FIG. 8A, in accordance with one or more embodiments.

FIG. 9 schematically illustrates a side view of a first arrangement for axially connecting two duct units, in accordance with one or more embodiments.

FIG. 10 schematically illustrates a side view of a second arrangement for axially connecting two duct units, in accordance with one or more embodiments.

FIG. 11 is a plan view of first configuration of paving blocks, in accordance with one or more embodiments.

FIG. 12 is a plan view of a second configuration of paving blocks, in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

By way of general introduction, embodiments of the present disclosure may include modularly designed duct units that may be used to simply installation of utility lines under roadways or footways. Duct units disclosed herein may be formed of multiple walls that may be assembled together to form a housing for one or more utility lines when buried underground. When disassembled, components of duct units may be flat packed (compactly stacked), which may allow for easy transportation to a construction site. Once on site, the duct units may be assembled and connected together via simple, straightforward connection elements, e.g., using at least one of male and female connections, “click and connect” connections, notches disposed on the modular walls, and other simple connection mechanisms. Thus, duct units according to embodiments described herein may be easy to remove, replace, and upgrade as may be required by a utility operator. Relatively quick setup and construction is afforded, leading to greater efficiency for laying and replacing the duct units.

Further, duct units according to embodiments of the present disclosure may be used in combination with a simplified installation system, which may include a polymer plate overlaying the duct unit, a layer of granular base material overlaying the polymer plate, and a plurality of interlocking paving blocks overlaying the base material. In accordance with one or more embodiments, base material may include at least one of a quantity of bedding sand and a quantity of base course. The paving blocks may be formed from concrete or another suitable material (e.g., recycled plastic) that may provide a surface for accommodating foot or vehicular traffic when assembled together.

Additionally, in accordance with one or more embodiments, one or more brackets may be removably fixed in a duct unit, which may hold a utility line within an interior volume defined by the duct unit. By way of example, such brackets could be angle brackets that can be mounted in one or more slots in modular walls of the duct unit.

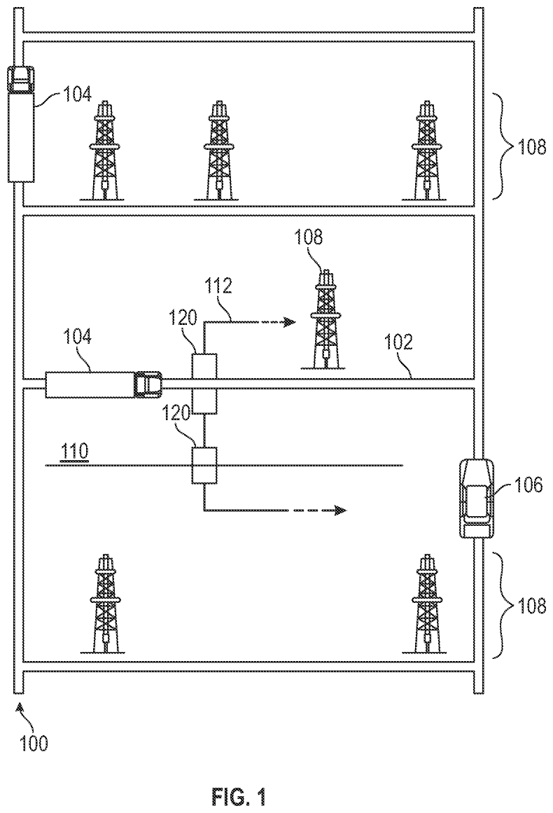

Turning now to the figures, to facilitate easier reference when describing FIGS. 1 to 12, reference numerals may be advanced by a multiple of 100 in indicating a similar or analogous component or element among FIGS. 1-12.

FIG. 1 schematically illustrates a road grid at an industrial site where duct units may be installed, in accordance with one or more embodiments. As shown, a road grid (or road network/arrangement) 100 may include a number of roadways 102 that may be considered primary roads, secondary roads, or access roads (in descending order of projected volumes of traffic), traversable by vehicles such as trucks 104 and cars 106. Roadways 102 may be paved or unpaved. If paved, roadways may include an upper road surface for accommodating vehicular traffic, where the upper road surface may be formed of concrete, asphalt, stone, paving bricks, or the like. By way of illustrative example, the industrial site may include oil well sites, including oil rigs 108, that are distributed along various roadways 102 of the road grid 100. There may also be included one or more footways 110 which accommodate pedestrian or light (e.g., non-motorized) vehicular traffic. For instance, a footway 110 may be a sidewalk near or adjacent a roadway 102, or may be a dedicated (paved or unpaved) footpath and/or bicycle path.

In accordance with one or more embodiments, particular locations at the industrial site (e.g., oil well sites 108), are typically accessed by utility lines such as cables or pipes for electricity, landline telephonic communication, water, gas, etc. In order for the utility lines 112 to safely cross roadways 102 and footways 110, and in order to accord ready access to such lines 112 from a roadway 102 or footway 110, the utility lines may be laid under the roadway 102 or footway 110 in duct units 120 according to embodiments of the present disclosure. For example, duct units holding one or more utility lines may be installed in a dugout trench, which may then be covered with materials for constructing the roadway 102 or footway 110.

It should be understood that FIG. 1 is provided merely as an illustrative example of a possible application of embodiments as broadly described and contemplated herein. Thus, in accordance with one or more embodiments, it is conceivable to install duct units as contemplated herein under roadways and footways at other possible types of industrial sites, or even at any of a great variety of possible residential sites.

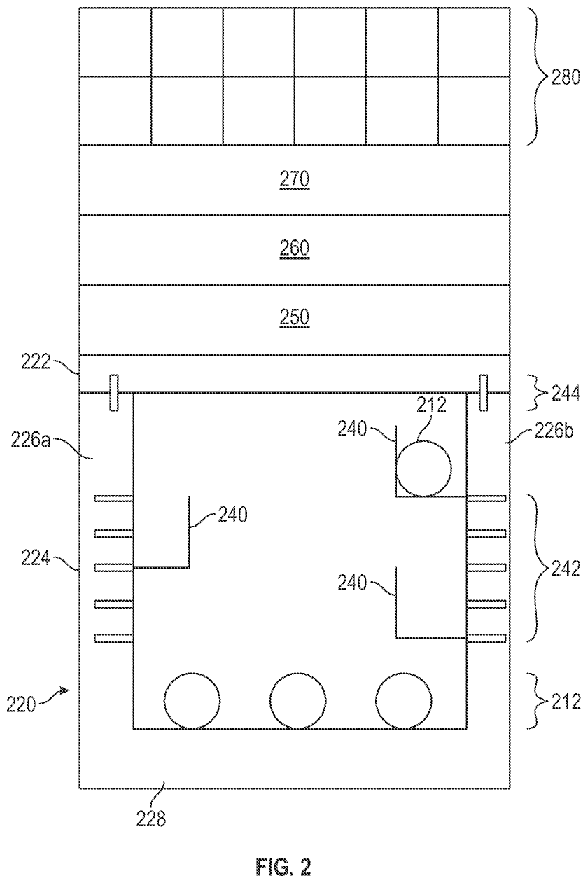

FIG. 2 is a schematic cross-sectional view of an installed duct unit and ancillary components, in accordance with one or more embodiments. As shown, one or more utility lines 212 may run through an interior volume of a duct unit 220, wherein modular walls 222 and 224 combine to form the duct unit 220 and define the interior volume. Here, the modular walls include a lid 222 and a generally U-shaped lower wall 224. The lower wall 224 includes side walls 226a and 226b extending perpendicularly from opposite sides of a base wall 228, where the side walls 226a/b and the base wall 228 may be integrally formed together as a single modular wall. In other embodiments, side walls and a base wall may be formed as separate modular walls that may be connected together when assembling the duct unit. Both the lid 222 and the lower wall 224 are formed from a polymer material of sufficient strength and material properties to accommodate foot or (light/heavy) vehicular traffic as described herein.

The walls of duct units described herein may be referred to as being modular in that same type walls may be constructed to have a standardized size and shape. For example, modular walls of multiple duct units may include side walls having the same size and shape, base walls having the same size and shape, and lids having the same size and shape. The modularly designed walls may then be assembled to form modular duct units having the same size and shape.

The duct unit 220 shown in FIG. 2 may have open axial ends (not shown from the cross-sectional perspective), in which case, the duct unit 220 may be referred to as a utility duct. According to embodiments of the present disclosure, multiple duct units 220 may be axially connected together in an end-to-end fashion, where utility lines 212 may extend through the open axial ends of the ducts. In such embodiments, connection elements (e.g., male and female connection elements) may be provided on the axial ends of the modular walls, which may be used for connecting the axial ends of different duct units 220.

In some embodiments, described in more detail below, duct units may be structured as an enclosed housing with closed axial ends, in which case the duct unit may be referred to as a vault, and where utility lines may extend through one or more openings formed through the vault walls. Such a vault may be in the form of a junction, where utility lines may meet from different directions to be redirected and/or intersect or join with one another.

In accordance with one or more embodiments, brackets 240 may be removably fixed in the duct unit 220 to hold one or more utility lines 212 within the interior volume of the duct unit, e.g., above a floor or base portion of the duct unit 220. As shown, the brackets 240 may be embodied by angle brackets defined by two perpendicular legs, such that one of the legs may suitably be fixed (selectively and removably) into one of several slots 242 formed in side wall portions of lower wall 224. In some embodiments, one or more utility lines 212 may run directly along the floor or base portion of the lower wall 224.

In accordance with one or more embodiments, one or more connection elements 244 may be provided for connecting the lid 222 and lower wall 224. The connection elements may include integrally formed structural features of the modular walls 222, 224, or may include separate components such as bolts or clips. Possible implementations of connection elements 244 will be further appreciated herebelow.

In accordance with one or more embodiments, when installing a duct unit 220 under a roadway or footway, additional installation elements may be provided. For example, as shown, a polymer plate 250 may be provided to overlay and protect the entire duct unit 220. This polymer plate 250 may be formed from the same or different polymer material as that forming the modular walls 222, 224 of duct unit 220. Additionally, a quantity of granular base material may be provided to overlay the duct unit 220 and/or polymer plate 250. The granular base material may include a layer of base course 260, which overlays the duct unit 220 and/or polymer plate 250, and a layer of bedding sand 270, which overlays the base course 260. The base course 260 may be a Class A aggregate base course with a CBR (California Bearing Ratio) value of 100 percent. Generally, the type of bedding sand 270 and base course 260 employed may be chosen in a manner deemed most suitable or expedient to meet any needs or requirements of the project at hand, including any local and/or international standards that may apply where the construction is carried out.

In accordance with one or more embodiments, a plurality of interlocking paving blocks 280 may be provided to overlay the granular base material (e.g., base course 260 and bedding sand 270). The paving blocks may combine to form a surface for accommodate foot or vehicular traffic and may be disposed in one or more layers as deemed suitable for the specific application at hand. The blocks may be formed from any material considered sufficient for the intended traffic, e.g. concrete or in some cases even polymer. The paving block surface may be sufficient alone for accommodating pedestrian or vehicular traffic, or may be overlayed by another paving surface such as asphalt. In any case, it can be appreciated that interlocking paving blocks 280 may easily be dismantled once installed, to accord relatively easy access to the duct unit 220 underneath. As noted further above, the paving blocks 280 may be formed from concrete or another suitable material (e.g., recycled plastic).

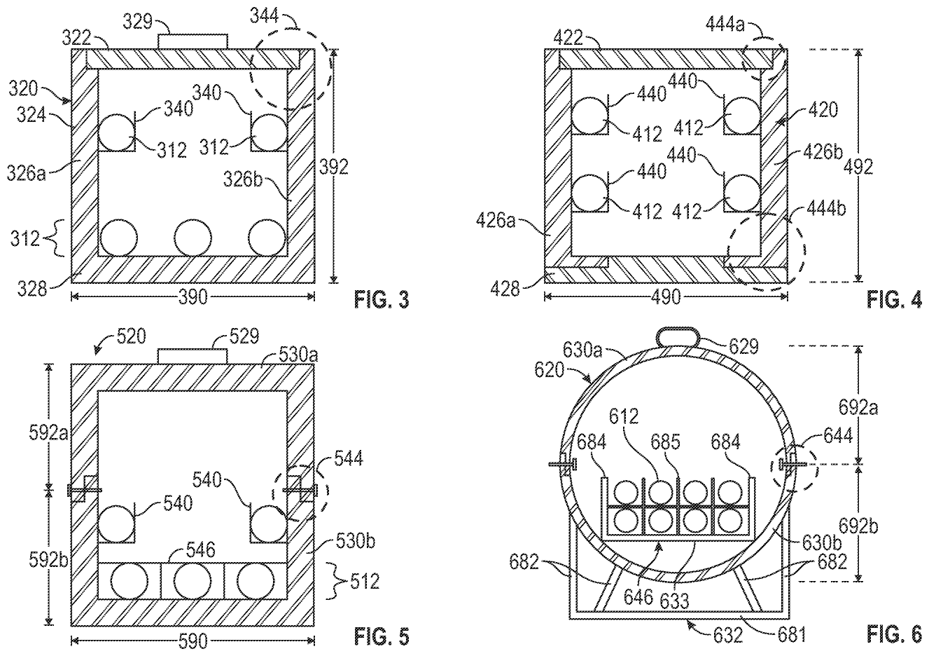

The disclosure now turns to some working examples of duct units in accordance with one or more embodiments, as described and illustrated with respect to FIGS. 3-8B. It should be understood and appreciated that these merely represent illustrative examples, and that a great variety of possible implementations are conceivable within the scope of embodiments as broadly contemplated herein.

FIG. 3 is an elevational cross-sectional view of a utility duct with a U-shaped lower wall, in accordance with one or more embodiments. In this example, modular walls 322 and 324 combine to form duct unit 320 and define an interior volume therewithin. The modular walls include a lid 322 and a generally U-shaped lower wall 324 which is defined by opposing side walls 326a and 326b and a base wall 328 extending between bottom ends of the side walls 326a, 326b. The lid 322 may be generally flat or, in one or more variant embodiments, may be shaped differently (e.g., generally curved in an upward direction with respect to the base wall 328). Further, the lid 322 may be positioned on top ends of the side walls 326a, 326b. Angle brackets 340 may be mounted in the side walls 326a, 326b as shown, to hold one or more utility lines 312 within the interior volume defined by duct unit 320. Additionally, one or more utility lines 312 may simply be directed to run atop the base wall 328.

In accordance with one or more embodiments, the arrangement shown in FIG. 3 may be understood as having open axial ends, i.e., in a direction going into and out of the drawing. With open axial ends, the duct unit 320 may be interfaced or connected axially with one or more other duct units or structures in suitable manner, or otherwise may be a “stand-alone” unit with no interface or connection with other duct units or structures. A similar understanding may also apply to FIGS. 4-7 as discussed and illustrated herein.

In accordance with one or more embodiments, an interconnection interface 344 between the lid 322 and a side wall 326b may be embodied by one or more notches formed at the top end of the side wall 326b. The opposite side wall 326a may be configured similarly, for a similar purpose. Different types of notched arrangements are conceivable for this purpose. For instance, the notches may be structured such that the lid 322 rests in the notches of the side walls 326a, 326b or engages in a form-locked connection with the notches. The lid 322 may include a handle 329 to facilitate lifting the lid 322 away from the side walls 326a, 326b. By way of illustrative example, the handle 329 may be a rigid, unitary physical extension of lid 322, may be hinged so that it folds into a compatibly recess in the lid 322, or may be flush with an upper surface of lid 322 (e.g., the handle may be a cylindrical bar which extends across a recess of sufficient depth to accommodate fingers of a human hand).

By way of sample dimensions, in accordance with one or more embodiments, the duct unit 320 may have an overall width 390 of between about 0.5 and about 1.5 m, and an overall height 392 of between about 0.5 and about 1.5 m.

FIG. 4 is an elevational cross-sectional view of a utility duct with L-shaped side walls, in accordance with one or more embodiments. As shown, duct unit 420 may include modular walls in the form of: a lid 422; two L-shaped side walls 426a and 426b; and a base wall 428. When the duct unit 420 is disassembled, the base wall 428, side walls 426a, 426b, and the lid 422 may be laid flat and stacked on top of each other for transporting. Such compact packing arrangement may reduce costs and burdens in transporting the duct unit 420 between locations. To assemble the duct unit 420, the lid 422 may be positioned on top ends of side walls 426a, 426b via one or more upper interconnection interfaces 444a embodied by notches in side walls 426a, 426b. At the same time, lower interconnection interfaces 444b may be embodied by grooves formed on opposite sides of a top surface of base wall 428, where the bottom ends of the “L-shape” side walls 426a, 426b (the protruding portion of the side wall 426a, 426b) are fitted into the grooves of base wall 428.

In accordance with one or more embodiments, similar to the arrangement shown in FIG. 3, angle brackets 440 may be removably fixed in side walls 426a, 426b to hold one or more utility lines 412 within the interior volume defined by duct unit 420.

By way of sample dimensions, in accordance with one or more embodiments, the duct unit 420 may have an overall width 490 of between about 0.5 and about 1.5 m, and an overall height 492 of between about 0.5 and about 1.5 m.

In accordance with one or more embodiments, FIGS. 5 and 6 illustrate variants where modular walls of a duct unit are embodied in each case by semi-unit walls. FIG. 5 is an elevational cross-sectional view of a duct unit 520 with upper and lower “half square” semi-unit walls 530a and 530b. Particularly, an upper semi-unit wall 530a (with a half-square cross-sectional profile) includes an upper, lid portion and two upper side wall portions extending from opposite sides of the lid portion, while a lower semi-unit wall 530b (with a half-square cross-sectional profile) includes a base portion and two lower side wall portions extending from opposite sides of the base portion. The upper semi-unit wall 530a may include a handle 529 as discussed heretofore.

In accordance with one or more embodiments, the “half-square” semi-unit walls 530a and 530b may have similar dimensions, e.g., a common (overall) width 590 and substantially equivalent heights (592a and 592b, respectively), when viewed in transverse cross-section (as in FIG. 5), or in variant embodiments, the dimensions may be different (e.g., the same width and different heights). As such, merely by way of sample dimensions in an illustrative working example, the overall width 590 may be between about 0.5 and about 1.5 m, and substantially equivalent heights (592a and 592b) of the semi-unit walls (530a and 530b, respectively), may each be between about 0.25 and about 0.75 m.

In accordance with one or more embodiments, connection elements 544 may be provided to interconnect the semi-unit walls 530a, 530b at either or both lateral sides thereof. Connection elements 544 may include notches and/or grooves in a male-female configuration, and may alternatively (or additionally) include one or more bolts or clips. In the embodiment shown in FIG. 5, the ends of the upper semi-unit wall 530a and the lower semi-unit wall 530b may have a mating groove and lip configuration, where a bolt may extend through the mating groove and lip to hold the connection together.

In accordance with one or more embodiments, angle brackets 540 may be removably fixed inside one or more of the semi-unit walls 530a, 530b, to hold one or more utility lines 512 within the interior volume defined by duct unit 520. Additionally or alternatively, a compartmented box structure 546 may be provided to direct one or more utility lines 512 atop the base portion of lower semi-unit wall 530b. Though the box structure 546 can assume any one of a very wide variety of conceivable forms, as shown in FIG. 5 it could be defined, e.g., by one or more vertical dividers which intersect a horizontal upper portion, thereby forming a plurality of smaller volumes through which one or more utility lines 512 can be directed.

FIG. 6 is an elevational cross-sectional view of a duct unit 620 with upper and lower semi-unit walls 630a, 630b shaped as “half pipe” structural portions, in accordance with one or more embodiments. Particularly, an upper semi-unit wall 630a (with a semicircular cross-sectional profile) may include an upper, lid portion (e.g., an uppermost portion of the semicircular cross-sectional profile defined over a smaller arc) and two upper side wall portions extending from opposite sides of the lid portion, while a lower semi-unit wall 630b (with a semicircular cross-sectional profile) may include a base portion (e.g., a lowermost portion of the semicircular cross-sectional profile defined over a smaller arc) and two lower side wall portions extending from opposite sides of the base portion. The upper semi-unit wall 630a may include a handle 629 as discussed heretofore. The “half-pipe” semi-unit walls 630a and 630b may have similar dimensions when viewed in transverse cross-section (as in FIG. 6), or may have different dimensions.

In accordance with one or more embodiments, a support 632 may also be provided which is integral with or otherwise connected to the lower semi-unit wall 630b. The support 632, which may run partly or fully over the entire longitudinal extent of duct unit 620 (i.e., in a direction into and out of the drawing), may include (as depicted) a horizontal base portion 681 with several support legs 682 extending upwardly therefrom (to interface or connect with the lower semi-unit wall 630b).

In accordance with one or more embodiments, connection elements 644 may be provided to interconnect semi-unit walls 630a, 630b at either or both lateral sides thereof. Connection elements 644 may include mating grooves and lips in a male-female configuration, and may alternatively (or additionally) include one or more bolts or clips to hold the mating connection elements together.

In accordance with one or more embodiments, a compartmented box structure 646 may be provided to hold and direct one or more utility lines 612 within the interior volume defined by duct unit 620. Though the box structure 646 can assume any one of a very wide variety of conceivable forms, the box structure 646 shown in FIG. 6 includes a horizontal base portion 683, two vertical side walls 684 extending upwardly from the horizontal base portion, and (within a space defined by the horizontal base portion and vertical side walls) an internal lattice 685 which includes one or more vertical dividers intersecting one or more horizontal dividers. Thus, a plurality of smaller volumes may be formed in the box structure, through which one or more utility lines 612 can be directed. In the implementation shown, the horizontal base portion of box structure 646 rests along an interior surface of lower semi-unit wall 630b, but may otherwise be connected to that interior surface in any suitable manner. In the implementation shown, a polymer plate may be installed immediately above upper semi-unit wall 630a, and could assume a compatible shape, e.g., in the form of a curved member which matches the curvature of upper semi-unit wall 630a. Base course, sand, and interlocking bricks may be layered over the polymer plate to support a road above the duct unit.

In accordance with one or more embodiments, the “half-pipe” semi-unit walls 630a and 630b may have substantially equivalent heights (692a and 692b, respectively), when viewed in transverse cross-section, while defining a single, common diameter for the entirety of the duct unit 620. In variant embodiments, the height dimensions 692a and 692b may be different. As such, merely by way of sample dimensions in an illustrative example, substantially equivalent heights (692a and 692b) of the semi-unit walls (630a and 630b, respectively), may each be between about 0.25 and about 0.75 m, while a single, common diameter of the entirety of the duct unit 620 may then be between about 0.5 and about 1.5 m.

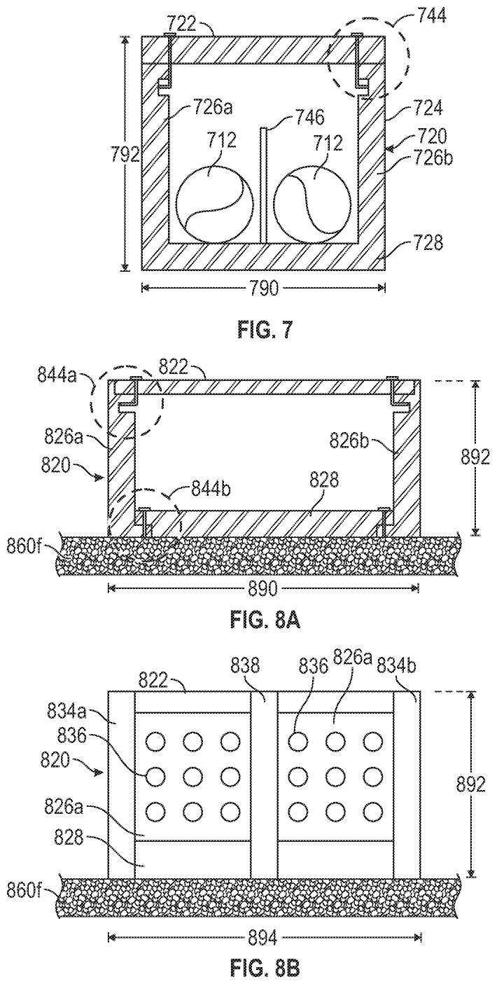

FIG. 7 is an elevational cross-sectional view of a duct unit 720 for installation under a footway, in accordance with one or more embodiments. The duct unit 720 may have a similar general configuration as the embodiment of FIG. 3 but with generally smaller dimensions. As shown in this example, modular walls 722 and 724 combine to form duct unit 720 and define an interior volume therewithin. The modular walls include a lid 722 and a generally U-shaped lower wall 724 which is defined by opposite side walls 726a, 726b and a base wall 728 extending between lower ends of the side walls 726a, 726b. The lid 722 may be positioned on top ends of the side walls 726a, 726b.

In accordance with one or more embodiments, connection elements 744 may be provided to connect the lid 722, at either or both lateral sides thereof, with the side walls 726a, 726b. As shown, connection elements 744 may be embodied by one or more notches formed at the top end of side wall 726b, along with a clip or notch bolt (e.g., a lockable notch bolt) which can extend through the lid to hook into the notch. The opposite side wall 726a, and laterally opposite portion of lid 722, may be configured similarly, for a similar purpose.

As shown, in accordance with one or more embodiments, a divider element 746 may be provided in order to direct utility lines 712 within the interior volume defined by duct unit 720. The divider element may be fixed (e.g., form-fit or friction-fit) into a slot disposed in base wall 728, or the divider element may be integrally formed with the lower wall 724. Utility lines 712 may be directed to run atop the base wall 728 and through the divided portions of the lower wall 724.

By way of sample dimensions, in accordance with one or more illustrative embodiments, the duct unit 720 may have an overall width 790 of between about 0.30 and about 1.5 m, a length (into and out of the drawing) of between about 0.5 and about 2 m, and an overall height 792 of between about 0.3 and about 1.5 m. Further, the lid 722 may have a thickness ranging between 0.08 and 1.5 in (e.g., about 1.0 in.), as may each of the side walls 726a, 726b and base wall 728.

FIGS. 8A and 8B show an example of a duct unit 820, here in the form of a utility vault, that may be a junction where utility lines may meet from different directions to be redirected and/or intersect or join with one another. As used herein, a junction may refer to a duct unit 820 having openings formed through one or more walls to allow utility lines to go in different directions through the duct unit.

FIG. 8A is a side, cross-sectional view of the utility vault 820, in accordance with one or more embodiments. The duct unit 820 may include modular walls in the form of: a lid 822; two L-shaped side walls 826a and 826b; a base wall 828; and two end walls (not shown by the cross-sectional view in FIG. 8A). Upper connection elements 844a may be provided to connect lid 822, at either or both lateral sides thereof, with side walls 826a, 826b. As shown, the upper connection elements 844a may be embodied similarly to those shown and described with respect to FIG. 7 (at 744a). Lower connection elements 844b may be provided to interconnect base wall 828, at both lateral sides thereof, with side walls 826a and 826b, respectively. Connection elements 844b may include notches and/or grooves in a male-female configuration as discussed heretofore and may alternatively (or additionally) include one or more bolts or clips to hold mating connection elements together. A layer of foundation base course 860f may also be provided to support the vault.

In accordance with one or more embodiments, the utility vault of FIG. 8A is formed by a plurality of modular walls that combine to form a vault structure, which structurally encloses the interior volume defined by the modular walls. The utility vault 820 of FIG. 8A does not include open axial ends as in the conduit-type duct structures described and illustrated herein with respect to FIGS. 3-7. FIG. 8B provides a front elevational view of the utility vault 820 of FIG. 8A, showing additional elements of the vault 820.

In accordance with one or more embodiments, as shown in FIG. 8B, axial ends of utility vault 820 may be defined by additional modular walls, or end walls 834a and 834b. Side wall 826a, for its part, may be embodied by two perforated wall portions as shown, divided by a central divider portion 838. It should be appreciated that opposite side wall 826b (see FIG. 8A) may be configured similarly, where the central divider portion 838 may divide utility lines running through the vault 820 into separate compartments and direct them in particular directions. Each perforated wall portion of side wall 826a may respectively extend to each of the lid 822, base wall 828 and divider portion 838, and include a plurality of through holes or openings 836, each structured to hold and direct a utility line within the interior volume defined by utility vault 820. As such, the openings 836 can be understood as structural elements for holding a utility line within the interior volume, but do not preclude the use of one or more additional structural elements for holding and/or directing a utility line within that interior volume (e.g., such as the angle brackets described and illustrated herein). Also, though not shown in FIG. 8B, it should be understood that either or both of end walls 834a and 834b may also include openings similar to openings 836.

By way of sample dimensions, in accordance with one or more embodiments, the vault 820 may have an overall width (890 in FIG. 8A) of between about 1.0 and about 6.0 m, an overall length (894 in FIG. 8B) of between about 1.5 and about 6.0 m, and an overall height 892 (in both FIGS. 8A and 8B) of between about 1.0 and about 3.0 m. Further, the lid 822 may have a thickness of about 1.0 in. (or more) while the side walls 826a, 826b and base wall 828 may each have a thickness of between about 2.0 and about 3.0 in. Additionally, the openings 836 may each be between about 2.0 in. and about 4.0 in. in diameter, and may be separated from one another (measured center-to-center), vertically and/or horizontally, by a distance of between about 150 mm and about 200 mm. Further, the foundation base course 860f may be a Class A aggregate base course with a CBR (California Bearing Ratio) value of 100 percent, laid out in a thickness of about 150 mm.

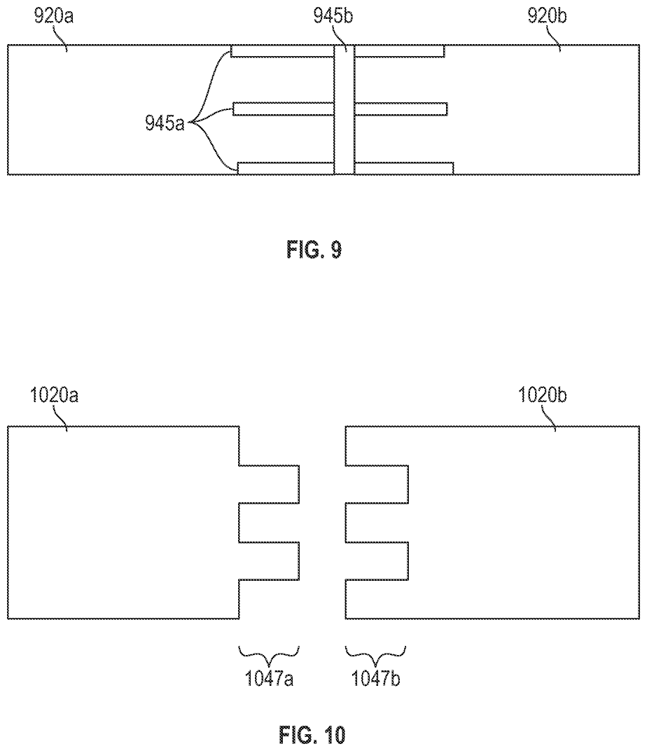

As noted above, multiple duct units may be axially connected together in an end-to-end fashion. For example, FIG. 9 schematically illustrates, in a side view, a working example of a first arrangement for axially connecting two duct units 920a and 920b. This may be understood as a “click and slot” embodiment, where a brace structure may be provided including a number of horizontal braces 945a (e.g., three) attached to a perpendicular cross-brace 945b. The horizontal braces 945a may fit in form-locking (e.g., “clicking”) fashion into compatible and similarly dimensioned slots in each of the duct units 920a and 920b. For its part, the cross-brace 945b may serve as a buffer or divider between duct units 920a and 920b, and/or may fit into one or more compatibly dimensioned recesses in duct units 920a and 920b. Generally, the horizontal braces 945a and cross-brace 945b may end up lying flush with respect to external surfaces of each of the duct units 920a and 920b. Further, the configuration shown in FIG. 9 may also be duplicated on one or more of the remaining three sides of the duct units 920a and 920b.

In accordance with one or more embodiments, FIG. 10 schematically illustrates a side view of a working example of a second arrangement for axially connecting two duct units 1020a and 1020b. This may be understood as a “male/female” structural connection. As shown, a first duct unit 1020a may be structured at a free end to include male connection elements 1047a, while a second duct unit 1020b may be structured at a free end to include female connection elements 1047b which engage with the male connection elements 1047a. Though there are a wide variety of possible implementations, in the working example shown the male connection elements 1047a may be embodied by a pair of rectilinear protrusions extending from a main body portion of first duct unit 1020a, while the female connection elements may be embodied by a pair of similar dimensioned rectilinear recesses extending into a main body portion of the second duct unit 1020b. Once the duct units 1020a/b are interconnected via connection elements 1047a/b, additional elements such as bolts or clamps may be provided to hold the structure in place more securely.

It should further be appreciated, in accordance with one or more embodiments, that individual duct units (e.g., such as 920a/b and 1020a/b shown in FIGS. 9 and 10) need not necessarily be straight along an axial direction. Alternatively, individual duct units may be curved or angled as may be required or desired to suit the parameters of a site (e.g., at a particular road or street). Generally, duct units may be connected end-to-end over essentially any desired overall length.

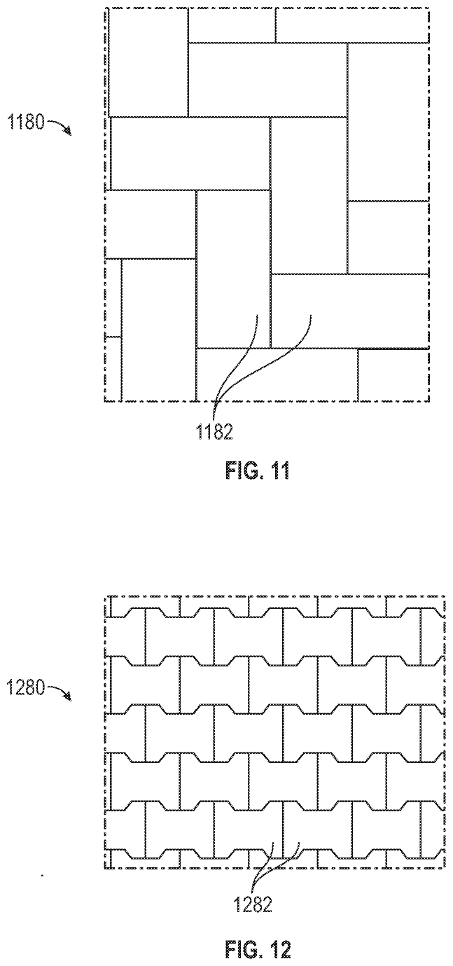

FIGS. 11 and 12 illustrate working examples of possible implementations of paving blocks as discussed herein (e.g., see 280 in FIG. 2). FIG. 11 is a plan view of a first configuration 1180 of a paving block layer. As shown, individual paving blocks 1182 may be rectilinear in (two-dimensional) shape, and may be arranged, e.g., so as to lie in a perpendicular orientation with respect to neighboring blocks and in a structurally interlocked, nesting manner. FIG. 12 is a plan view of a second configuration 1280 of a paving block layer, in accordance with one or more embodiments. Here, individual blocks 1282 may each have a dumbbell (two-dimensional) shape, with wider left and right ends and a narrower central portion. The configurations shown in FIGS. 11 and 12 alike may be disposed in one layer or multiple layers (e.g., as shown in FIG. 2).

By way of sample dimensions, in accordance with one or more embodiments, blocks 1182 in FIG. 11 may be about 230 mm long, 100 mm wide, and (in a direction going into the figure) 50-75 mm thick. The individual blocks 1282 in FIG. 12 may have similar or analogous dimensions.

By way of some conceivable technical specifications, in accordance with one or more embodiments, modular walls or wall portions of a duct unit (e.g., see 222 and 224 in FIG. 2) may be formed from a polymer having at least one property selected from a group consisting of: a Shore D hardness of between about 70 and about 83; a bending modulus of between about 1.2 and about 1.6 GPa; a compressive strength at rupture or yield of between about 24 and about 49 MPa; a tensile strength at break of between about 20 and about 40 MPa; a tensile strength at yield of between about 35 and about 40 MPa; a Young's modulus of between about 1.1 and about 1.6 GPa; a Heat Distortion Temperature (HDT) at 0.46 MPa of between about 100 degrees C. and about 120 degrees C.; an HDT at 1.8 MPa of between about 50 degrees C. and about 60 degrees C.; a Maximum Continuous Service Temperature of between about 100 degrees C. and about 130 degrees C.; and a Minimum Continuous Service Temperature of between about −20 degrees C. and about −10 degrees C. Similar properties may also apply to a polymer plate (e.g., see 250 in FIG. 2) which overlays a duct unit. Such properties are generally highly favorable throughout the embodiments and variants broadly contemplated herein, especially in view of absorbing loads from foot or vehicular traffic traversing a roadway or footway about the duct unit. It should also be understood that the specific properties employed may be tailored in accordance with strictures or guidelines associated with a local climate or temperature profile. Further, the polymer material employed may be selected from a great variety of possible types of polymers. For instance, the polymer material may be thermoset, thermoplastic, recycled, reinforced, or non-reinforced.

It can be appreciated that, in accordance with one or more embodiments, methods of enclosing a utility line under a roadway or footway are also broadly contemplated. In at least one conceivable method, a plurality modular walls are provided to a work site, along with a quantity of granular base material and a plurality of interlocking paving blocks. The modular walls are formed from a polymer material and may be assembled to form a duct unit defining an interior volume therewithin and having open axial ends. One or more brackets may be removably fixed in the duct unit to hold a utility line within the interior volume. The quantity of granular base material may be overlayed over the duct unit, and the paving blocks may be overlayed over the base material. The paving blocks may combine to form a surface for accommodating foot or vehicular traffic.

In this connection, it should be appreciated that a method of enclosing a utility line under a roadway or footway, as broadly contemplated herein, may involve selecting components of the installation that are readily tailored to projected types and volumes of traffic. Thus, duct unit sizes and configurations may be so selected, along with the dimensions and types of layers (e.g., sand, base course and paving blocks) that may end up overlaying one or more duct units.

Accordingly, by way of merely illustrative examples in accordance with one or more embodiments, the following specifications are conceivable for different “layers” of a duct/vault installation, with general reference to elements illustrated in FIG. 2 (and applicable to other illustrated embodiments). For access roads, or local roads with residential traffic, a polymer plate 250 may be about 0.50 in. thick (e.g., flat or curved in shape, to match the outer shape of an upper portion of a duct unit as discussed herein), a layer of base course 260 may be about 250 mm thick, a layer of bedding sand 270 may be about 30 mm thick, and one layer of interlocking concrete blocks 280 may be provided with a thickness of about 80 mm. For secondary roads with low to medium traffic and possibly some truck traffic, a polymer plate 250 may be about 1.0 in. thick, a layer of base course 260 may be about 230 mm thick a layer of bedding sand 270 may be about 30 mm thick, and two layers of interlocking concrete blocks 280 may be provided where each layer has a thickness of about 80 mm. For primary roads or highways, with medium to heavy traffic including an appreciable degree of truck traffic, a polymer plate 250 may be about 1.5 in. thick, a layer of base course 260 may be about 300 mm thick, a layer of bedding sand 270 may be about 30 mm thick, and three layers of interlocking concrete blocks 280 may be provided where each layer has a thickness of about 80 mm.

In accordance with one or more embodiments, it should further be appreciated that consolidated packing (e.g., “flat packing”) of constituent components of a duct unit can facilitate efficient construction and installation of the duct unit at a site. Such consolidated packing can be effected by disposing the constituent components in a box or container of limited height, via tying various components together, or in any other suitable manner where components physically occupy a reduced or compacted space in comparison with the dimensions of a fully installed duct unit. As such, a related “kit” of components (reduced or compacted in overall size for convenient transport) may include major structural components of the duct unit itself, such as the modular walls described and illustrated with respect to different embodiments (e.g., U-shaped walls, lids, L-shaped walls, semi-unit walls, a support arrangement or portions thereof, e.g., as shown at 632 in FIG. 6, etc.) as well as connection elements such as nuts, bolts and/or clips. An additional polymer plate as discussed above (e.g., see 250 in FIG. 2) may be included as part of such a “kit”, or separately. Other components, e.g., the base course 260, bedding sand 270 and interlocking paving blocks 280 described with respect to FIG. 2, may form part of the “kit”, or may themselves be provided separately to the work site.

It can be appreciated from the foregoing that, in accordance with one or more embodiments, components of non-metallic (e.g., polymer) ducts and vaults can be transported and installed with relative ease, in a modular form, which permits quick and efficient construction at a work site. A layered pavement construction above a duct or vault, as broadly contemplated herein, can also be relatively easy to dismantle and/or remove for easy subsequent access to the duct or vault, e.g., eliminating much time and effort that may otherwise be associated with cutting up the roadway or footway. Generally, this will greatly reduce the time needed for utility upgrades and changes and will generally reduce or eliminate the need for associated inconveniences such as traffic delays and detours from road restrictions and closures. Further, the use of polymers may promote a “circular economy” where recycling can lead to viable re-use after the useful life of a duct unit.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A system for enclosing a utility line under a roadway or footway, the system comprising:
a plurality of modular walls formed from a polymer material, wherein the modular walls combine to form a duct unit defining an interior volume therewithin and having open axial ends;
a quantity of granular base material overlaying the duct unit;
a plurality of interlocking paving blocks overlaying the granular base material, wherein the plurality of paving blocks combine to form a surface for accommodating foot or vehicular traffic; and
one or more brackets removably fixed in the duct unit for holding the utility line within the interior volume.

2. The system according to claim 1, wherein the modular walls comprise:
a base wall having grooves formed on opposite sides of a top surface of the base wall;
two side walls, wherein bottom ends of the side walls are fitted into the grooves of the base wall to assemble the side walls perpendicularly to the base wall; and
a lid, wherein the lid is positioned on top ends of the side walls.

3. The system according to claim 2, wherein opposite sides of the lid are fitted into notches formed on the top ends of the side walls.

4. The system according to claim 1, wherein the modular walls comprise:
two semi-unit walls, comprising:
a lower send-unit wall having a base portion and two lower side wall portions extending from opposite sides of the base portion; and
an upper semi-unit wall having a lid portion and two upper side wall portions extending from opposite skies of the lid portion;
wherein the lower side wall portions and the upper side wall portions are connected together to form the duct unit.

5. The system according to claim 4, wherein the lower and upper semi-unit walls each have a semicircular cross-sectional profile.

6. The system according to claim 1, wherein the one or more brackets are removably fixed into one or more slots formed in the modular walls.

7. The system according to claim 1, further comprising:
one or more openings disposed through at least one of the modular walls;
the one or more openings each being structured to hold and direct a utility cable or utility pipe within the interior volume.

8. The system according to claim 1, wherein the modular walls comprise:
a lower wall having a base portion and two side wall portions forming a unitary, generally U-shaped structure; and
a lid, wherein the lid is positioned on top ends of the side walls.

9. The system according to claim 1, further comprising a polymer plate disposed between the duct unit and the granular base material.

10. The system according to claim 1, wherein the granular base material includes a quantity of bedding sand and a quantity of base course.

11. The system according to claim 10, wherein the base course is a Class A aggregate base course with a California Bearing Ratio (CBR) value of 100 percent.

12. The system according to claim 1, wherein one or more of the modular walls is formed from a polymer having at least one property selected from a group consisting of:
a Shore D hardness of between about 70 and about 83;
a bending modulus of between about 1.2 and about 1.6 GPa;
a compressive strength at rupture or yield of between about 24 and about 49 MPa;
a tensile strength at break of between about 20 and about 40 MPa;
a tensile strength at yield of between about 35 and about 40 MPa;
a Young's modulus of between about 1.1 and about 1.6 GPa;
a Heat Distortion Temperature (HDT) at 0.46 MPa of between about 100 degrees C. and about 120 degrees C.;
an HDT at 1.8 MPa of between about 50 degrees C. and about 60 degrees C.;
a Maximum Continuous Service Temperature of between about 100 degrees C. and about 130 degrees C.; and
a Minimum Continuous Service Temperature of between about minus 20 degrees C. and about minus 10 degrees C.

13. A method, comprising:
providing to a work site:
a plurality of modular walls, wherein the modular walls are formed from a polymer material;
a quantity of granular base material; and
a plurality of interlocking paving blocks;
assembling the modular walls to form a duct unit defining an interior volume therewithin and having open axial ends;
removably fixing one or more brackets in the duct unit to hold a utility line within the interior volume;
overlaying the quantity of granular base material over the duct unit; and
overlaying the plurality of interlocking paving blocks over the base material, wherein the plurality of paving blocks combine to form a surface for accommodating foot or vehicular traffic.

14. The method according to claim 13, wherein:
the plurality of modular walls comprise:
a base wall and two side walls forming a unitary, generally U-shaped structure; and
a lid;
said assembling comprising positioning the lid on top ends of the side walls.

15. The method according to claim 13, wherein:
the plurality of modular walls comprise:
a base wall having grooves formed on opposite sides of a top surface of the base wall;
two side walls; and
a lid;
said assembling comprising:
fitting bottom ends of the side walls into the grooves of the base wall to assemble the side walls perpendicularly to the base wall; and
positioning the lid on top ends of the side walls.

16. The method according to claim 13, wherein the removably fixing comprises removably fixing the brackets into to one more slots formed in the modular walls.

17. The method according to claim 13, wherein:
the quantity of granular base material includes a quantity of bedding sand and a quantity of base course;
wherein the quantity of bedding sand is overlayed over the quantity of base course, and the quantity of base material is overlayed over the quantity of bedding sand.

18. The method according to claim 13, further comprising overlaying a polymer plate over the duct unit, between the duct unit and the granular base material.

19. The method according to claim 13, wherein one or more of the modular walls is formed from a polymer having at least one property selected from a group consisting of:
a Shore D hardness of between about 70 and about 83;
a bending modulus of between about 1.2 and about 1.6 GPa;
a compressive strength at rupture or yield of between about 24 and about 49 MPa;
a tensile strength at break of between about 20 and about 40 MPa;
a tensile strength at yield of between about 35 and about 40 MPa;
a Young's modulus of between about 1.1 and about 1.6 GPa;
a Heat Distortion Temperature (HDT) at 0.46 MPa of between about 100 degrees C. and about 120 degrees C.;
an HDT at 1.8 MPa of between about 50 degrees C. and about 60 degrees C.;
a Maximum Continuous Service Temperature of between about 100 degrees C. and about 130 degrees C.; and
a Minimum Continuous Service Temperature of between about minus 20 degrees C. and about minus 10 degrees C.

20. A system for enclosing a utility line under a roadway or footway, the system comprising:
a plurality of modular walls formed from a polymer material, wherein the modular walls combine to form a duct unit defining an interior volume;
a polymer plate overlaying the duct unit;
a quantity of granular base material overlaying the polymer plate; and
a plurality of interlocking paving blocks overlaying the granular base material, wherein the plurality of paving blocks combine to form a surface for accommodating foot or vehicular traffic.
